(19) United States
(12) Patent Application Publication
(10) Pub. No.: US 2009/0239615 A1
(43) Pub. Date: Sep. 24, 2009

(54) Slot Machine Having Special Symbol And Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/191,638

(22) Filed: Aug. 14, 2008

Related U.S. Application Data
(60) Provisional application No. 61/038,997, filed on Mar. 24, 2008.

(51) Int. Cl. A63F 13/00; A63F 9/24

(52) U.S. Cl. 463/20; 463/16

(57) ABSTRACT

A slot machine of the present invention comprises: a display for arranging thereto a normal symbol and a special symbol having a plurality of payout patterns each associated with a payout value; and a controller programmed to execute processing of (B) stop-displaying the payout patterns having been variably displayed, in the case that the special symbol has been rearranged to the display, and (D) determining an amount of special payout based on a type of the payout pattern stop-displayed in the processing (B).

### CROSS-REFERENCE TO RELATED APPLICATIONS

This application claims benefit of priority based on U.S. Provisional Patent Application No. 61/038,997 filed on Mar. 24, 2008. The contents of this application are incorporated herein by reference in their entirety.

### BACKGROUND OF THE INVENTION

1. Field of the Invention

The present invention relates to a slot machine having special symbols and a control method thereof.

2. Discussion of the Background

In conventional slot machines, when a player inserts game media such as medals, coins or bills into an insertion slot of the slot machine and presses a spin button, then a plurality of symbols are scroll-displayed to a display portion provided on the front surface of a casing and, thereafter, the respective symbols are automatically stopped, as disclosed in U.S. Pat. No. 6,960,133, U.S. Pat. No. 6,012,983, and U.S. Pat. No. 6,093,102. In this case, when scroll-display of respective symbols starts by an input from the spin button, symbols are selected using random numbers, and the selected symbols are stop-displayed to the display portion. Then, when a combination of the stop-displayed symbols along a winning line is a predetermined winning combination (prize), a payout is conducted. As described above, in these slot machines, a payout is varied depending on the positions of displayed symbols.

Further, among conventional slot machines, there are some slot machines which conduct two types of payouts which are a payout determined according to the combinations of symbols rearranged along winning lines and a payout determined according to the number of displayed scatter symbols, as disclosed in U.S. Pat. No. 6,604,999 and US 2002-0065124-A1. In such a slot machine which conducts payouts based on such scatter symbols, there is no relationship between payouts and positions at which the scatter symbols are displayed.

Particularly, a slot machine which employs symbols all of which are constituted by scatter symbols (hereinafter, referred to as an all-scatter type slot machine) employs no concept of winning lines. That is, such a slot machine determines payouts regardless of the positions of symbols displayed to the display portion. As described above, such an all-scatter type slot machine uniquely conducts a payout based on the number of displayed symbols, without determining the presence or absence of the payout or varying an amount of the payout depending on the positions of displayed symbols. This may make games monotonous, thereby causing a player to get easily bored with games.

The present invention has been devised in view of the aforementioned circumstances and an object thereof is to provide a slot machine configured to rearrange scatter symbols in which a player hardly gets bored, and a control method thereof.

The contents of U.S. Pat. No. 6,960,133, U.S. Pat. No. 6,012,983, U.S. Pat. No. 6,093,102, U.S. Pat. No. 6,604,999 and US 2002-0065124-A1 are incorporated herein by reference in their entirety.

### SUMMARY OF THE INVENTION

The first aspect of the present invention provides a slot machine having the following configuration.

Namely, the slot machine comprises: a display for arranging thereto a normal symbol and a special symbol having a plurality of payout patterns each associated with a payout value; and a controller. The controller is programmed to execute processing of (A) rearranging the normal symbol and/or the special symbol to the display, (B) stop-displaying the payout patterns having been variably displayed, in the case that the special symbol has been rearranged to the display in the processing (A), (C) determining an amount of normal payout based on a number of the normal symbol for each type, the normal symbol having been rearranged in the processing (A), and (D) determining an amount of special payout based on a type of the payout pattern stop-displayed in the processing (B).

According to the slot machine, a special symbol having a plurality of payout patterns each associated with a payout value, as well as a normal symbol, is rearranged to a display. In the case that the special symbol has been rearranged to the display, the payout patterns having been variably displayed are stop-displayed, and an amount of special payout is determined based on a type of the payout pattern stop-displayed therein. Namely, even in the case that the special symbol is rearranged to the display, the payout value is not uniquely determined, but the payout value is varied depending on the type of the stop-displayed payout pattern, out of the plurality of payout patterns included in the special symbol. This prevents the game from becoming monotonous, so that the player hardly gets bored.

Further, the rearrangement of the special symbol to the display can make the player have a sense of expectancy as to which of the payout patterns to be stop-displayed.

Preferably, the slot machine further has the following configuration.

Namely, the controller is further programmed to execute processing of (E) determining as the amount of special payout a numerical value obtained by multiplying the amount of special payout determined in the processing (D) by a specified number, in the case that the types of the payout patterns stop-displayed in the processing (B) in all of the special symbols rearranged to the display in the processing (A) are the same.

According to the slot machine, in the case that the types of the payout patterns stop-displayed in all the special symbols rearranged to the display are the same, a numerical value obtained by multiplying the amount of payout based on the rearranged special symbols by a specified number is determined as the amount of special payout. Namely, when the types of the payout patterns in all the special symbols are the same, the amount of special payout larger than a normal amount is determined. Accordingly, in the case that the plurality of special symbols are rearranged to the display, the player can be excited about whether or not all the payout patterns to be stop-displayed will be the same, and also, the player can be absorbed in the game.

Further, when the types of the payout patterns of all the special symbols are the same, the amount of special payout larger than the normal amount is determined, which makes the game easy to understand, thereby allowing even a beginner to play the game without having an uncomfortable feeling.

Preferably, the slot machine further has the following configuration.

Namely, the processing (D) includes processing of (D−1) determining as the amount of special payout a numerical value obtained by multiplying the amount of special payout determined based on the type and a number of the payout pattern by the specified number, in the case that a number of the special symbols having the same type of the payout patterns stop-displayed in the processing (B), out of the special symbols rearranged to the display in the processing (A), is equal to or more than a predetermined number.

According to the slot machine, in the case that the number of special symbols having the same type of payout patterns stop-displayed therein, out of special symbols rearranged to the display is equal to or more than a predetermined number, a numerical value obtained by multiplying an amount of payout based on the special symbols by the specified number is determined as the amount of special payout. Namely, when the number of special symbols having the same type of payout patterns is equal to or more than the predetermined number, the amount of special payout larger than the normal amount is determined. Accordingly, in the case that special symbols in number equal to or more than the predetermined number are rearranged to the display, this can excite the player and also can make the player absorbed in the game.

Further, by properly setting the predetermined number, it is possible to increase or decrease the opportunities to determine the amount of special payout larger than the normal amount, so that characteristics of the slot machine can be varied.

The second aspect of the invention provides a slot machine having the following configuration.

Namely, the slot machine comprising: a display for arranging thereto a normal symbol and a special symbol having a plurality of payout patterns each with a numeral indicative of a payout value; and a controller. The controller is programmed to execute processing of (A) rearranging the normal symbol and/or the special symbol to the display, (B) stop-displaying the payout patterns having been variably displayed, in the case that the special symbol has been rearranged to the display in the processing (A), (C) determining an amount of normal payout based on the number of the normal symbol for each type, the normal symbol having been rearranged in the processing (A), and (D) determining an amount of special payout based on the numeral on the payout pattern stop-displayed in the processing (B).

According to the slot machine, a special symbol having a plurality of payout patterns each with a numeral indicative of a payout value, as well as a normal symbol, is rearranged to a display. In the case that the special symbol has been rearranged to the display, the payout patterns having been variably displayed are stop-displayed, and an amount of special payout is determined based on a numeral on the payout pattern stop-displayed therein. Namely, even in the case that the special symbol is rearranged to the display, the payout value is not uniquely determined, but the payout value is varied depending on the numeral on the stop-displayed payout pattern, out of the plurality of payout patterns included in the special symbol. This prevents the game from becoming monotonous, so that the player hardly gets bored.

Further, the rearrangement of the special symbol to the display can make the player have a sense of expectancy as to which of the payout patterns to be stop-displayed.

Further, since a numeral indicative of the payout value is drawn on the payout pattern, the player can recognize the payout value easily.

Preferably, the slot machine further has the following configuration.

Namely, the processing (D) is processing of determining as the amount of special payout a numerical value obtained by multiplying the value of the numeral on the payout patterns in said special symbol by a number of the special symbols each having the payout pattern with the numeral stop-displayed therein and by a specified number, in the case that the numerals on the payout patterns stop-displayed in the processing (B) in all of the special symbols rearranged to the display in the processing (A) are the same.

According to the slot machine, in the case that the numerals on the payout patterns stop-displayed in all the special symbols rearranged to the display are the same, a numerical value obtained by multiplying the amount of payout based on the special symbols by the specified number is determined as the amount of special payout. Namely, when the numerals on the payout patterns in all the special symbols are the same, the amount of special payout larger than the normal amount is determined. Accordingly, in the case that a plurality of special symbols are rearranged to the display, the player can be excited about whether or not all the numerals on the payout patterns to be stop-displayed will be the same, and also, the player can be absorbed in the game.

Further, when the numerals on the payout patterns in all the special symbols are the same, the amount of special payout larger than the normal amount is determined, which makes the game easy to understand, thereby allowing even a beginner to play the game without having an uncomfortable feeling.

Preferably, the slot machine further has the following configuration.

Namely, the processing (D) includes processing of (D−1) determining as the amount of special payout a numerical value obtained by multiplying the value of the numeral on the payout pattern in the special symbol in number equal to or more than a predetermined number, by a number of the special symbol having the payout pattern with the numeral stop-displayed therein and by a specified number, in the case that the number of the special symbol having the payout pattern with the same numeral stop-displayed therein in the processing (B), out of the special symbol rearranged to the display in the processing (A), is equal to or more than the predetermined number.

According to the slot machine, in the case that the number of the special symbols having the payout patterns with the same numerals stop-displayed therein, out of the special symbols rearranged to the display, is equal to or more than the predetermined number, the numerical value obtained by multiplying the amount of payout based on the special symbols by the specified number is determined as the amount of special payout. Namely, when the numerals on the payout patterns in the special symbols in number equal to or more than the predetermined number are the same, the amount of special payout larger than the normal amount is determined. Accordingly, in the case that the special symbols in number equal to or more than the predetermined number are rearranged to the display, this can excite the player and also can make the player absorbed in the game.

Also, by properly setting the predetermined number, it is possible to increase or decrease the opportunities to determine the amount of special payout larger than the normal amount, so that characteristics of the slot machine can be varied.

The third aspect of the invention provides a slot machine having the following configuration.

Namely, the slot machine comprises: a display for arranging thereto a normal symbol and a special symbol having a plurality of payout patterns each with a numeral indicative of a payout value; and a controller. The controller is programmed to execute processing of (A) rearranging the normal symbol and/or the special symbol having the payout patterns stop-displayed therein to the display, (B) determining whether or not the special symbol in number equal to or more than a fixed number has been rearranged to the display in the processing (A), (C) stop-displaying the payout patterns after a variable display thereof, when determining in the processing (B) that the special symbol in number equal to or more than the fixed number has been rearranged, (D) determining an amount of normal payout based on a number of the normal symbol for each type, the normal symbol having been rearranged in the processing (A), and (E) determining an amount of special payout based on the numeral on the payout pattern stop-displayed in the processing (C).

According to the slot machine, special symbols having a plurality of payout patterns each with a numeral indicative of a payout value, as well as normal symbols, are rearranged to the display. Further, when the special symbols in number equal to or more than a fixed number are rearranged to the display, payout patterns are variably displayed and then stop-displayed therein. Furthermore, the amount of special payout is determined based on the numerals on the payout patterns stop-displayed therein. Namely, even when the special symbol is rearranged to the display, in the case that the special symbols in number equal to or more than the fixed number are not rearranged to the display, the payout patterns are not variably displayed therein and the amount of special payout is not determined. This can strongly impress the existence of special symbols on the player.

Further, even when the payout patterns in the special symbol are variably displayed, the payout value is not uniquely determined, but the payout value is varied depending on the numerals on the payout patterns stop-displayed therein, out of the plurality of payout patterns included in the special symbols. This prevents the game from becoming monotonous, so that the player hardly gets bored.

Further, when variable display of the payout patterns in the special symbols is started, this can make the player have a sense of expectancy as to which of the payout patterns to be stop-displayed.

Further, since a numeral indicative of the payout value is drawn on the payout pattern, the player can recognize the payout value easily.

The fourth aspect of the invention provides a control method of a slot machine, the method having the following configuration.

Namely, the control method of a slot machine comprises steps of: (A) rearranging to a display a normal symbol and/or a special symbol having a plurality of payout patterns each associated with a payout value; (B) stop-displaying the payout patterns having been variably displayed, in the case that the special symbol has been rearranged to the display in the step (A); (C) determining an amount of normal payout based on a number of the normal symbol for each type, the normal symbol having been rearranged in the step (A), and (D) determining an amount of special payout based on a type of the payout pattern stop-displayed in the step (B).

According to the control method of a slot machine, a special symbol having a plurality of payout patterns each associated with a payout value, as well as a normal symbol, is rearranged to a display. In the case that the special symbol has been rearranged to the display, the payout patterns having been variably displayed are stop-displayed, and an amount of special payout is determined based on a type of the payout pattern stop-displayed therein. Namely, even in the case that the special symbol is rearranged to the display, the payout value is not uniquely determined, but the payout value is varied depending on the type of the stop-displayed payout pattern, out of the plurality of payout patterns included in the special symbol. This prevents the game from becoming monotonous, so that the player hardly gets bored.

Further, the rearrangement of the special symbol to the display can make the player have a sense of expectancy as to which of the payout patterns to be stop-displayed.

### BRIEF DESCRIPTION OF THE DRAWINGS

FIG. 1A is an exemplary view of a symbol matrix.

FIG. 1B is another exemplary view of a symbol matrix.

FIG. 1C is another exemplary view of a symbol matrix.

FIG. 1D is another exemplary view of a symbol matrix.

FIG. 1E is another exemplary view of a symbol matrix.

FIG. 2 is a perspective view illustrating an external appearance of a slot machine of the present invention.

FIG. 3 is a view illustrating symbols displayed to respective display blocks and the code Nos. of the respective symbols.

FIG. 4 is a view illustrating payout patterns displayed in special symbols and code Nos. of the respective payout patterns.

FIG. 5 is a block diagram illustrating an internal configuration of the slot machine illustrated in FIG. 2.

FIG. 6 is a flowchart illustrating a procedure of an activation processing.

FIG. 7 is a view illustrating a peripheral-device initialization processing.

FIG. 8 is a flowchart illustrating a subroutine of symbol determination processing.

FIG. 9 is a flowchart illustrating a subroutine of symbol determination processing.

FIG. 10 is a flowchart illustrating a subroutine of scroll-display control processing.

FIG. 11 is a flowchart illustrating a subroutine of payout processing.

FIG. 12 is a view illustrating a relationship between a plurality of types of prizes and the numbers of coin-outs.

FIG. 13 is a flowchart illustrating a subroutine of payout processing according to the second embodiment.

FIG. 14 is a flowchart illustrating a subroutine of scroll-display control processing according to the third embodiment.

FIG. 15 is a flowchart illustrating a subroutine of payout processing according to the third embodiment.

### DESCRIPTION OF THE EMBODIMENTS

### First Embodiment

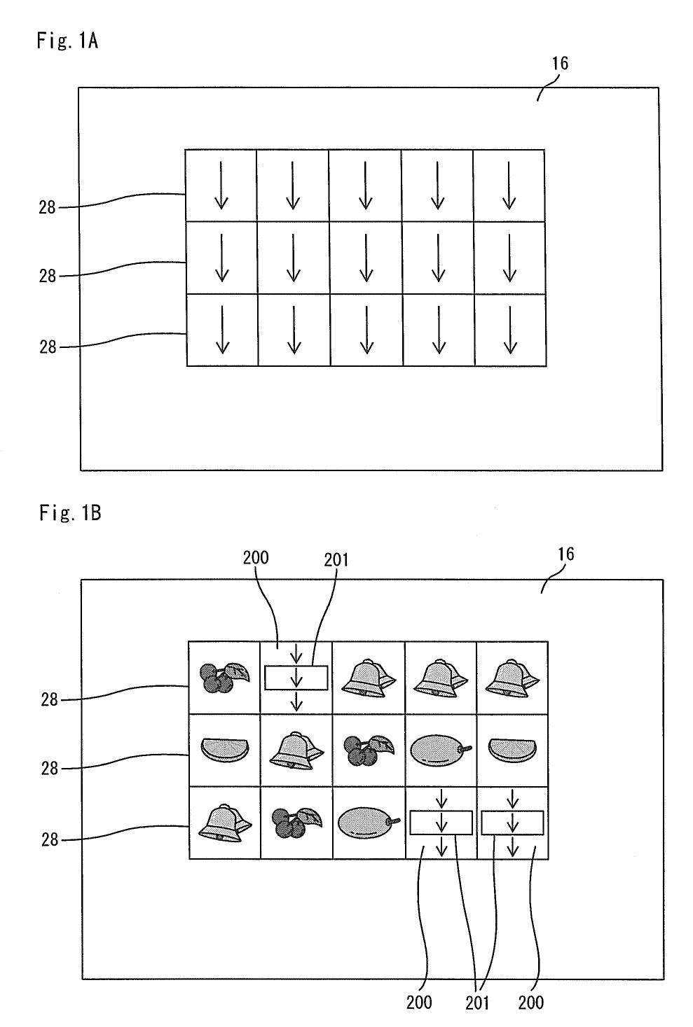

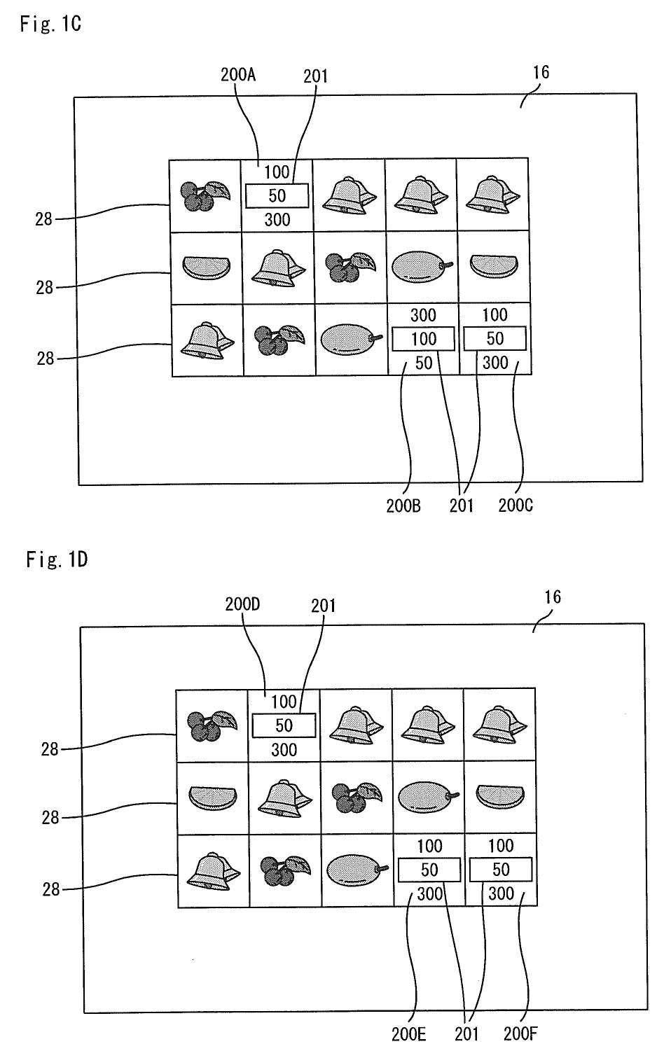

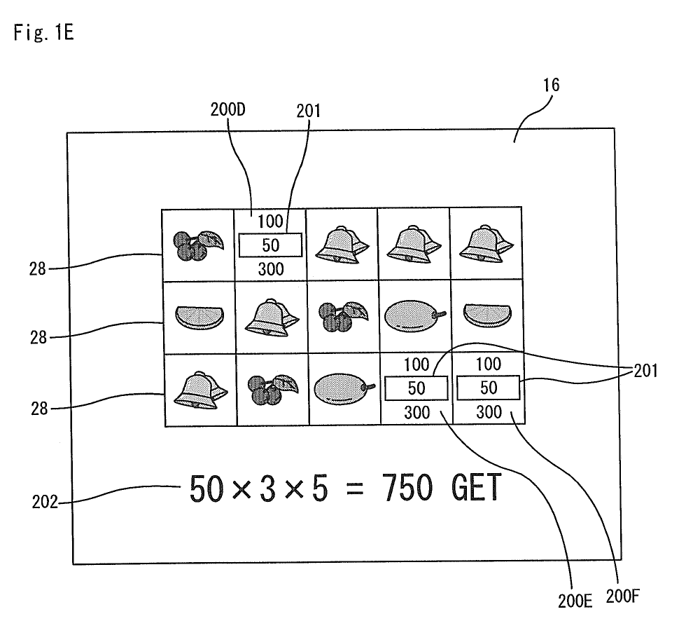

FIGS. 1A to 1E are exemplary views each illustrating a symbol matrix.

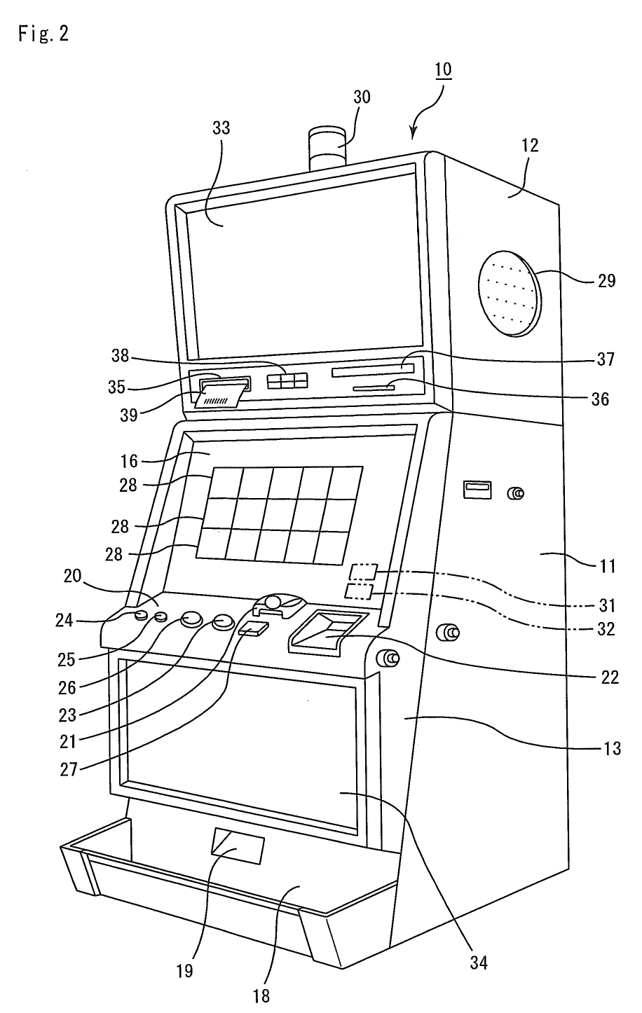

The symbol matrix SM illustrated in FIGS. 1A to 1E is displayed to a lower image display panel 16 (a display according to the present invention) included in a slot machine 10 (see FIG. 2). Display blocks 28 are capable of rearranging 15 symbols therein in total, along three rows and five columns. In the display blocks 28, a normal symbol and a special symbol 200 having a plurality of payout patterns each with a numeral indicative of a payout value are rearranged.

In the following description, both the normal symbol and the special symbol will be simply referred to as symbols.

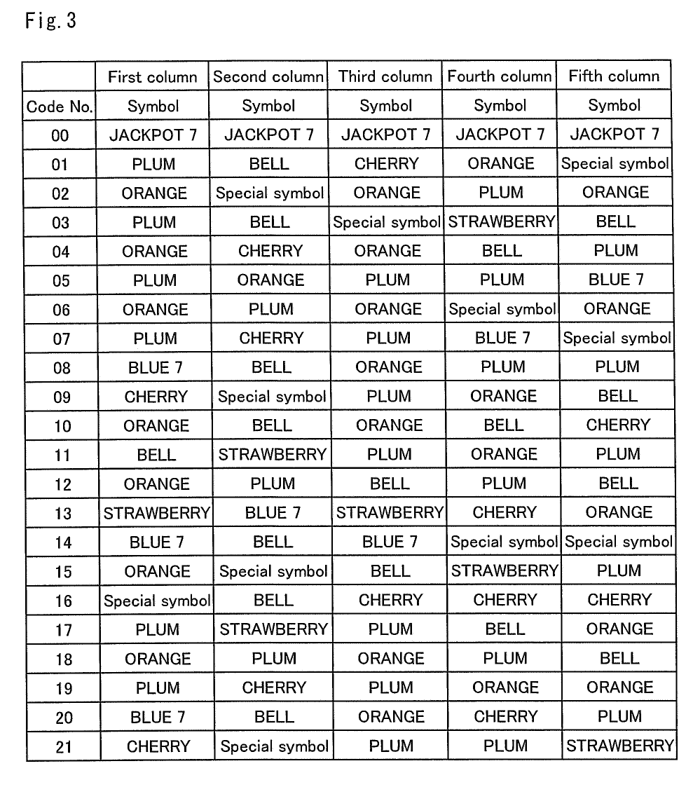

When a player presses a spin button 23 (see FIG. 3) included in the slot machine 10, scrolling of symbols is started in the symbol matrix SM, as illustrated in FIG. 1A.

Thereafter, as illustrated in FIG. 1B, 15 symbols are rearranged. Normal symbols such as “BELL” and “CHERRY” are stop-displayed, while special symbols 200 are displayed such that payout patterns are scroll-displayed in the special symbols 200.

Thereafter, as illustrated in FIG. 1C, the payout patterns having been scroll-displayed in the symbol are stop-displayed. The numeral on the payout pattern stop-displayed in a payout display frame 201 indicates a payout value. The payout based on a special symbol 200A is 50 coins, the payout based on a special symbol 200B is 100 coins, and the payout based on a special symbol 200C is 50 coins. Further, coins in number corresponding to the total sum of the values of the numerals on the payout patterns stop-displayed in the payout display frames 201 are paid out as an amount of special payout. Namely, in the case that payout patterns in special symbols 200 are stop-displayed as illustrated in FIG. 1C, 200 coins, which correspond to the total sum of the values of the numerals on the payout patterns stop-displayed in the payout display frames 201, are paid out as the special payout.

On the other hand, there will be described a case where payout patterns are stop-displayed as illustrated in FIG. 1D, after the payout patterns are scroll-displayed in special symbols 200 as illustrated in FIG. 1B. In FIG. 1D, all the numerals on the payout patterns stop-displayed in the payout display frames 201 are the same (50). In this case, 150 coins are not paid out as the special payout, but 750 coins obtained by multiplying 150 coins by 5 (a specified number according to the present invention) are paid out as the special payout. Then, as illustrated in FIG. 1E, an amount-of-special-payout determination image 202 indicating that 750 coins will be paid out as the special payout is displayed below the symbol matrix SM.

There has been given a general description of the first embodiment, with reference to FIGS. 1A to 1E. Further, a normal payout based on the normal symbol will be specifically described in the following description.

Next, the configuration of the slot machine 10 will be described.

FIG. 2 is a perspective view illustrating the external appearance of the slot machine according to the present embodiment.

The slot machine 10 employs coins, bills or electronic valuable information corresponding thereto, as a game medium. However, in the present invention, a game medium is not particularly limited, and examples thereof may include a medal, a token, electronic money and a ticket. In addition, the ticket is not particularly limited, and examples thereof may include a ticket with a barcode, which will be described later, and the like.

The slot machine 10 includes a cabinet 11, a top box 12 installed on the upper side of the cabinet 11, and a main door 13 provided on a front surface of the cabinet 11.

A lower image display panel 16 is provided as a display on the main door 13. The lower image display panel 16 includes a transparent liquid crystal display panel that displays 15 display blocks 28 in five columns and three rows. Each display block 28 has one symbol displayed therein.

Further, a number-of-credits display portion 31 and a number-of-payouts display portion 32 are set to the lower image display panel 16. The number-of-credits display portion 31 displays an image indicative of the number of coins being credited. The number-of-payouts display portion 32 displays an image indicative of the number of coin-outs.

Further, a touch panel 69, although not illustrated, is provided on a front surface of the lower image display panel 16, and a player can input various types of commands by operating the touch panel 69.

Below the lower image display panel 16, there are provided a control panel 20 comprising a plurality of buttons 23 to 27 which enable the player to input commands relating to the game progress, a coin receiving slot 21 through which a coin is accepted into the cabinet 11, and a bill validator 22.

The control panel 20 is provided with a spin button 23, a change button 24, a CASHOUT button 25, a 1-BET button 26 and a maximum BET button 27. The spin button 23 is for inputting a command for starting scrolling of symbols. The change button 24 is used for making a request to staff of the recreation facility for exchange. The CASHOUT button 25 is for inputting a command for payout of credited coins into a coin tray 18.

The 1-BET button 26 is for inputting a command for betting a single coin on a game out of credited coins. The maximum BET button 27 is for inputting a command for betting, on a game, a maximum number of coins (50 coins, in the present embodiment) which can be BET on a single game, out of credited coins.

The bill validator 22 not only discriminates a regular bill from a false bill, but also accepts the regular bill into the cabinet 11. It should be noted that the bill validator 22 may be configured so as to be capable of reading a later-described ticket 39 with a barcode. On a front surface of the lower portion of the main door 13, namely below the control panel 20, there is provided a belly glass 34 on which a character of the slot machine 10 and the like is drawn.

On a front surface of the top box 12, an upper image display panel 33 is provided. The upper image display panel 33 includes a liquid crystal panel which displays, for example, images indicative of introduction of the contents of a game and explanation of the rules of games.

Further, speakers 29 are provided in the top box 12. Below the upper image display panel 33, there are provided a ticket printer 35, a card reader 36, a data display 37 and a keypad 38. The ticket printer 35 prints, on a ticket, a barcode as coded data of the number of credits, date, an identification number of the slot machine 10 and the like, and outputs the ticket as the ticket 39 with a barcode. The player can make another slot machine read the ticket 39 with a barcode to play a game on the slot machine, or can exchange the ticket 39 with a barcode to bills and the like at a predetermined location in the recreation facility (for example, a cashier in a casino).

The card reader 36 reads and writes data from and into a smart card. The smart card is a card owned by a player and stores, for example, data for identifying the player and data about the history of games having been played by the player. The smart card may store data corresponding to a coin, a bill or a credit. Also, instead of the smart card, a magnetic stripe card may be used. The data display 37 is comprised of, for example, a fluorescent display and displays, for example, data read through the card reader 36 and data inputted through the key pad 38 by the player. The key pad 38 is used for inputting commands and data relating to issuing tickets.

Further, although, in the present embodiment, there has been described the case where 15 symbols are displayed along five columns and three rows, the display of symbols according to the present invention is not limited to display along five columns and three rows. Further, although, in the present embodiment, there has been described the case symbols are scrolled along the respective columns, individual symbols may be independently scroll-displayed.

Further, although not illustrated, various types of images relating to effects, in addition to the aforementioned images, are displayed to the lower image display panel 16.

FIG. 3 is a view illustrating symbols displayed in the respective display blocks and the code Nos. of the respective symbols.

As illustrated in FIG. 3, in each display block 28, there is scrolled a symbol sequence consisting of 22 symbols in total, each of which has one of the code numbers “00” to “21”. Each of the symbol sequences consists of a combination of symbols of “JACKPOT 7”, “BLUE 7”, “BELL”, “CHERRY”, “STRAWBERRY”, “PLUM”, “ORANGE” and “Special symbol 200”. “JACKPOT 7”, “BLUE 7”, “BELL”, “CHERRY”, “STRAWBERRY”, “PLUM” and “ORANGE” correspond to normal symbols according to the present invention. These symbols are all scatter symbols, and coins are paid out on the basis of the numbers of these symbols displayed in the display blocks 28 at the time of rearrangement.

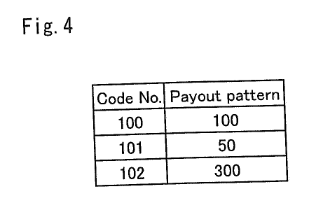

FIG. 4 is a view illustrating payout patterns displayed in the special symbols 200 and code Nos. of the respective payout patterns.

As illustrated in FIG. 4, total of three payout patterns each having one of code Nos. of “100” to “102” are scrolled in the respective special symbols 200.

Further, while, in the present embodiment, there has been described a case where the number of payout patterns is three, the number of payout patterns according to the present invention is not particularly limited and may be 10, for example.

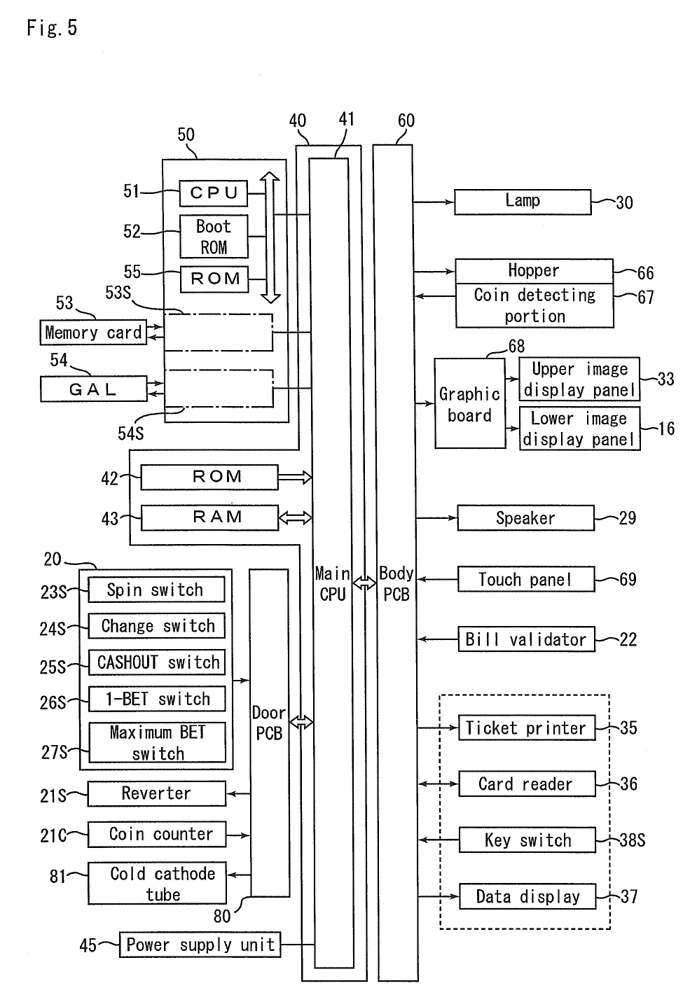

FIG. 5 is a block diagram illustrating the internal configuration of the slot machine illustrated in FIG. 2.

A gaming board 50 includes a CPU (Central Processing Unit) 51, a ROM 55 and a boot ROM 52 which are interconnected to one another via an internal bus, a card slot 53S corresponding to a memory card 53, and an IC socket 54S corresponding to a GAL (Generic Array Logic) 54.

The memory card 53 comprises a nonvolatile memory such as CompactFlash (registered trademark) and stores a game program. The game program includes a symbol determination program. The symbol determination program is a program for determining a symbol (code No. corresponding to a symbol) to be rearranged in each of the display blocks 28. Further, the game program includes a payout-pattern determination program. The payout-pattern determination program is a program for determining the payout pattern (code No. associated with the payout pattern) to be rearranged in the special symbol 200.

Further, the card slot 53S is configured so as to allow the memory card 53 to be inserted thereinto and ejected therefrom, and is connected to a mother board 40 via an IDE bus. Accordingly, it is possible to change the type and the contents of a game to be executed by the slot machine 10 by ejecting the memory card 53 from the card slot 53S, writing a different game program onto the memory card 53 and inserting the memory card 53 into the card slot 53S. The game program includes a program relating to the progress of a game. Further, the game program includes image data and sound data to be output during the game.

The CPU 51, the ROM 55 and the boot ROM 52 which are interconnected to one another via the internal bus are connected to the mother board 40 via a PCI bus. The PCI bus transfers a signal between the mother board 40 and the gaming board 50 and also supplies electricity from the mother board 40 to the gaming board 50.

The mother board 40 comprises a commercially-available general-purpose mother board (a printed wiring board with basic components of a personal computer mounted thereon), and includes the main CPU 41, a ROM (Read Only Memory) 42, a RAM (Random Access Memory) 43 and a communication interface 44. The mother board 40 corresponds to a controller according to the present invention.

The ROM 42 comprises a memory device such as a flash memory and stores programs of a BIOS (Basic Input/Output System) and the like to be executed by the main CPU 41 and also stores permanent data. When the BIOS is executed by the main CPU 41, processing for initializing predetermined peripheral devices is conducted, concurrently with start of processing for loading a game program stored in the memory card 53 through the gaming board 50. Further, in the present invention, the ROM 42 may be or may not be a content rewritable one.

Further, the ROM 42 stores numerical data indicative of a specified number, numerical data indicative of a predetermined number, and numerical data indicative of a fixed number.

Further, the ROM 42 stores a table indicative of a correspondence relationship between the symbol to be displayed in each of the display block and the code No. of each symbol, and a table indicative of a correspondence relationship between the payout pattern to be displayed in the special symbol 200 and the code No. of each payout pattern.

The RAM 43 stores data to be used upon operating the main CPU 41, and programs such as the symbol determination program and the payout-pattern determination program. Further, the RAM 43 can store a game program.

Further, the RAM 43 stores data about the code Nos. of the symbols, the code Nos. of the payout patterns, an amount of normal payout, an amount of special payout, an amount of bonus special payout, the number of credits, a number of coin-ins and a number of coin-outs per game, and the like.

Further, a body PCB (Printed Circuit Board) 60 and a door PCB 80, which will be described later, are connected to the mother board 40 through respective USBs. Further, a power-supply unit 45 is connected to the mother board 40.

The body PCB 60 and the door PCB 80 are connected with equipment and devices that generate input signals to be inputted to the main CPU 41 and equipment and devices operations of which are controlled by control signals outputted from the main CPU 41. The main CPU 41 executes a game program stored in the RAM 43 based on the input signal inputted to the main CPU 41, thereby executes the predetermined arithmetic processing and stores a result thereof in the RAM 43, or transmits a control signal to each of the equipment and devices as processing for controlling each of the equipment and devices.

A lamp 30, a hopper 66, a coin detecting portion 67, a graphic board 68, the speakers 29, the touch panel 69, the bill validator 22, the ticket printer 35, the card reader 36, a key switch 38S and the data display 37 are connected to the body PCB 60. The lamp 30 lights up in a predetermined pattern on the basis of a control signal outputted from the main CPU 41.

The hopper 66 is installed inside the cabinet 11 and pays out a predetermined number of coins to the coin tray 18 through a coin payout exit 19 on the basis of control signals outputted from the main CPU 41. The coin detection portion 67 is provided inside the coin payout exit 19 and outputs an input signal to the main CPU 41 upon detecting a predetermined number of coins being paid out from the coin payout exit 19.

The graphic board 68 controls an image display to the upper image display panel 33 and the lower image display panel 16, on the basis of a control signal outputted from the main CPU 41. The lower image display panel 16 displays in each of the display blocks 28 a symbol that is scrolled or stopped. The number-of-credits display portion 31 of the lower image display panel 16 displays the number of credits stored in the RAM 43. Further, the number-of-payouts display portion 32 of the lower image display panel 16 displays the number of coin-outs.

The graphic board 68 includes a VDP (Video Display Processor) for generating image data on the basis of a control signal outputted from the main CPU 41, a video RAM for temporarily storing the image data generated by the VDP, and the like. Further, such image data for use in generation of the image data by the VDP is included in a game program which is read from the memory card 53 and stored in the RAM 43.

The bill validator 22 discriminates a regular bill from a false bill, and also accepts the regular bill into the cabinet 11. The bill validator 22, upon receiving a regular bill, outputs an input signal to the main CPU 41 on the basis of the face amount of the bill. The main CPU 41 stores in the RAM 43 a number of credits corresponding to the face amount of the bill transmitted with the input signal.

The ticket printer 35 prints on a ticket a barcode as coded data of the number of credits stored in the RAM 43, date, an identification number of the slot machine 10, and the like, and outputs the ticket as the ticket 39 with a barcode.

The card reader 36 reads data from a smart card and transmits the data to the main CPU 41, or writes data into the smart card on the basis of a control signal from the main CPU 41. The key switch 38S is provided on the key pad 38 and outputs a predetermined input signal to the main CPU 41 when the player operates the key pad 38. The data display 37 displays data read by the card reader 36 or data inputted through the key pad 38 by the player, on the basis of a control signal outputted from the main CPU 41.

The control panel 20, a reverter 21S, a coin counter 21C and a cold cathode tube 81 are connected to the door PCB 80. The control panel 20 is provided with a spin switch 23S corresponding to a spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. The respective switches 23S to 27S output input signals to the main CPU 41, when the player operates the buttons 23 to 27 corresponding thereto.

The coin counter 21C is provided inside the coin receiving slot 21 and discriminates a regular coin from a false coin inserted into the coin receiving slot 21 by the player. Coins other than regular coins are discharged from the coin payout exit 19. Further, the coin counter 21C outputs an input signal to the main CPU 41, upon detecting a regular coin.

The reverter 21S operates on the basis of a control signal outputted from the main CPU 41 and distributes coins identified by the coin counter 21C as regular coins into a cash box (not illustrated) or the hopper 66, which are installed inside the slot machine 10. Namely, when the hopper 66 is filled with coins, a regular coin is distributed into the cash box by the reverter 21S. On the other hand, when the hopper 66 is not filled with coins, a regular coin is distributed into the hopper 66. The cold cathode tube 81 functions as a backlight installed on the rear face side of the lower image display panel 16 and the upper image display panel 33 and lights up on the basis of a control signal outputted from the main CPU 41.

### [Activation Processing]

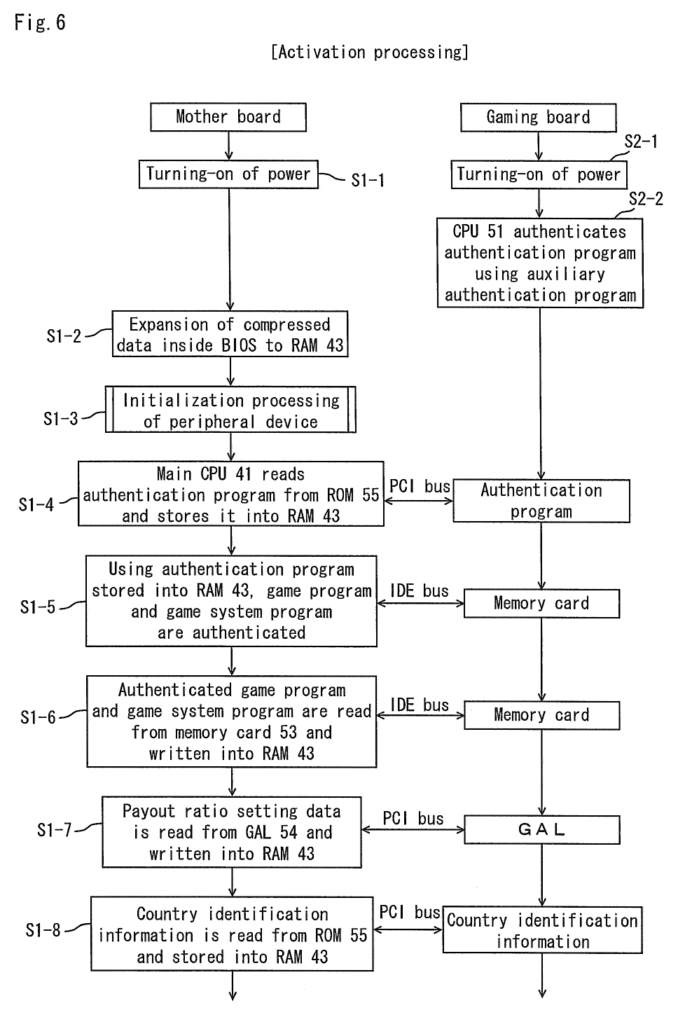

FIG. 6 is a flowchart illustrating a procedure of an activation processing. The activation processing is performed in the mother board 40 and the gaming board 50. It is to be noted that the memory card 53 is inserted into the card slot 53S in the gaming board 50 and the GAL 54 is mounted on the IC socket 54S.

First, when the power switch is turned on (the power is turned on) in the power unit 45, the mother board 40 and the gaming board 50 are activated (steps S1-1, S2-1). When the mother board 40 and the gaming board 50 are activated, separate processing are executed in parallel. Namely, in the gaming board 50, the CPU 51 reads an auxiliary authentication program stored in the boot ROM 52 and conducts auxiliary authentication according to the read auxiliary authentication program, to previously check and prove that an authentication program is not falsified before loading the program to the mother board 40 (step S2-2). Meanwhile, in the mother board 40, the main CPU 41 executes the BIOS stored in the ROM 42, and expands compressed data which is incorporated in the BIOS into the RAM 43 (step S1-2). The main CPU 41 then executes the BIOS expanded into the RAM 43 to diagnose and initialize a variety of peripheral devices (step S1-3). The processing in step S1-3 will be specifically described later with reference to drawings.

Since the ROM 55 of the gaming board 50 is connected to the main CPU 41 via the PCI bus, the main CPU 41 reads the authentication program stored in the ROM 55, and stores the read authentication program into the RAM 43 (steps S1-4). At this time, according to the standard BIOS function of BIOS, the main CPU 41 takes a checksum by ADDSUM system (normal checking system) and stores the authentication program into the RAM 43, while conducting processing for confirming whether or not the storage is certainly conducted.

Next, after confirming what is connected to the IDE bus, the main CPU 41 accesses, via the IDE bus, the memory card 53 inserted in the card slot 53S, to read a game program and a game system program from the memory card 53. In this case, the main CPU 41 reads data constituting the game program and the game system program by 4 bytes. Subsequently, the main CPU 41 conducts authentication to check and prove that the read game program and game system program have not been falsified, following the authentication program stored in the RAM 43 (step S1-5). When this authentication processing is normally completed, the main CPU 41 writes and stores the game program and the game system program, which have been the authentication targets (which have been authenticated), into the RAM 43 (step S1-6). Next, the main CPU 41 accesses, via the PCI bus, the GAL 54 mounted on the IC socket 54S, reads payout ratio setting data from the GAL 54, and writes and stores the data into the RAM 43 (step S1-7). Subsequently, the main CPU 41 conducts processing for reading country identification information stored in the ROM 55 of the gaming board 50 via the PCI bus, and writes and stores the read country identification information into the RAM 43 (step S1-8).

After conducting the above-mentioned processing, the main CPU 41 sequentially reads and executes the game program and the game system program, thereby execute a game execution processing.

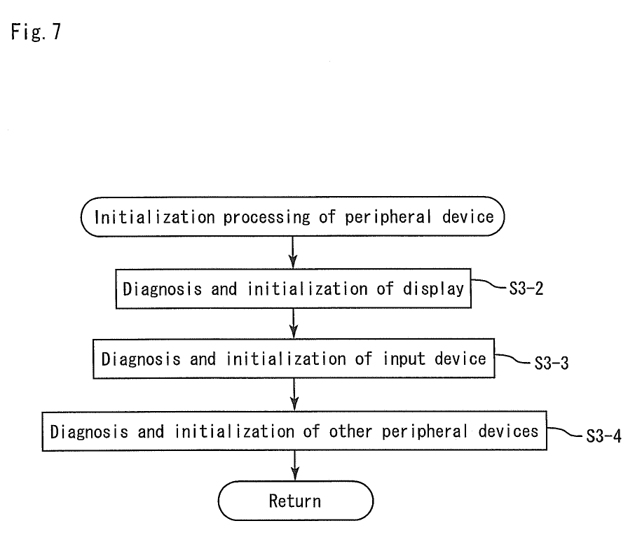

FIG. 7 is a view illustrating peripheral-device initialization processing.

First, the main CPU 41 diagnoses and initializes a display (step S3-2). In the processing, the main CPU 41 transmits a request signal to the graphic board 68. Then, the main CPU 41 determines whether or not to have received a predetermined response signal and conducts clearance of a predetermined storage area, and the like.

Next, the main CPU 41 diagnoses and initializes various types of input devices (step S3-3). In this processing, the main CPU 41 transmits request signals to the input devices such as the spin switch 23S, the change switch 24S, the CASHOUT switch 25S, the 1-BET switch 26S, the maximum BET switch 27S, and the touch panel 11, and then determines whether or not to have received predetermined response signals.

Subsequently, the main CPU 41 diagnoses and initializes other peripheral devices connected to the main CPU 41 (step S3-4). Then, the present subroutine is terminated.

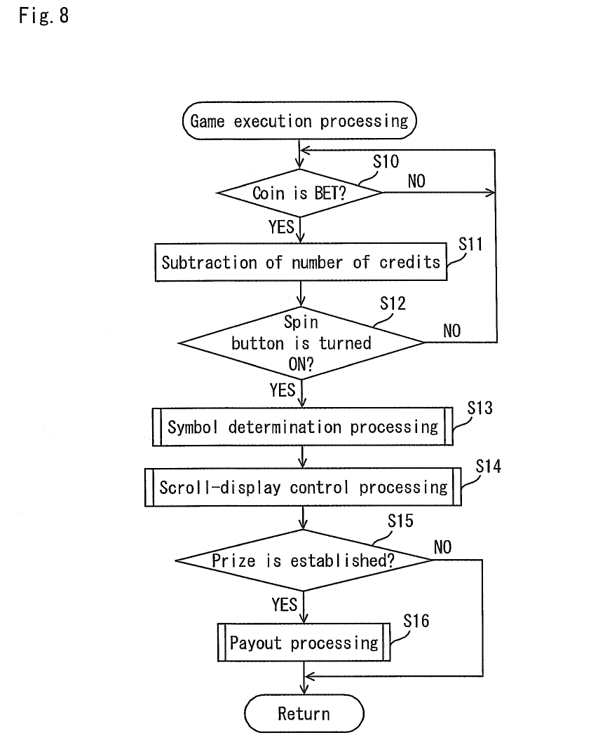

FIG. 8 is a flowchart illustrating a subroutine of game execution processing.

In the game execution processing, at first, the main CPU 41 determines whether or not a coin has been BET (step S10). In this processing, the main CPU 41 determines whether or not to have received an input signal outputted from the 1-BET switch 26S when the 1-BET button 26 is operated or an input signal outputted from the maximum BET switch 27S when the maximum BET button 27 is operated. When determining that a coin has not been BET, the main CPU 41 returns the processing to step S10.

On the other hand, when determining in step S10 that a coin has been BET, the main CPU 41 executes processing of making a subtraction from the number of credits stored in the RAM 43 according to the number of BET coins (step S11). Further, when the number of BET coins is larger than the number of credits stored in the RAM 43, the main CPU returns the processing to step S10, without executing the processing of making a subtraction from the number of credits stored in the RAM 43. Further, when the number of BET coins exceeds an upper limit value of coins that can be BET on a single game (50 coins, in the present embodiment), the processing is carried forward to step S12, without executing the processing of making a subtraction from the number of credits stored in the RAM 43.

Next, in step S12, the main CPU 41 determines whether or not the spin button 23 has been turned on. In this processing, the main CPU 41 determines whether or not to have received an input signal outputted from the spin switch 23S when the spin button 23 is pressed.

When it is determined that the spin button 23 has not been turned on, the processing is returned to step S10. Further, when the spin button 23 has not been turned on (for example, when a command for ending a game is inputted without turning on the spin button 23), the main CPU 41 cancels the result of the subtraction in step S11.

On the other hand, when it is determined in step S12 that the spin button 23 has been turned on, the processing is shifted to step S13.

Next, in step S13, the main CPU 41 executes symbol determination processing. In the symbol determination processing, the main CPU 41 determines a code No. of the symbol on stopping by executing the symbol determination program stored in the RAM 43.

Here, the processing in step S13 will be specifically described later with reference to drawings.

In step S14, the main CPU 41 executes scroll-display control processing.

The processing is processing of display control for rearranging the symbol determined in step S13 after scroll of symbols is started.

Here, the processing in step S14 will be specifically described later with reference to drawings.

In step S15, the main CPU 41 determines whether or not a prize has been established. When determining that a prize has been established, in step S16, the main CPU 41 pays out coins on the basis of the number of coin-ins and the types and the numbers of the symbols displayed in the display blocks 28. Here, the case where a prize has been established is a case where three or more normal symbols of the same type have been displayed in the display blocks 28 or a case where one or more special symbols 200 have been displayed in the display blocks 28.

Further, the processing in step S16 will be specifically described later with reference to the drawings.

When it is determined in step S15 that a prize has not been established or when the processing in step S16 has been executed, the present subroutine is terminated.

Further, while, in the present embodiment, there has been described a case where the special payout is provided in the case that one or more special symbols are displayed in the display blocks 28, in the present invention, the special payout can be provided in the case that special symbols in number equal to or more than the fixed number are displayed in the display blocks 28. Further, in the case that special symbols in number equal to or more than the fixed number are not displayed, payout patterns having been variably displayed in special symbols may be not stop-displayed.

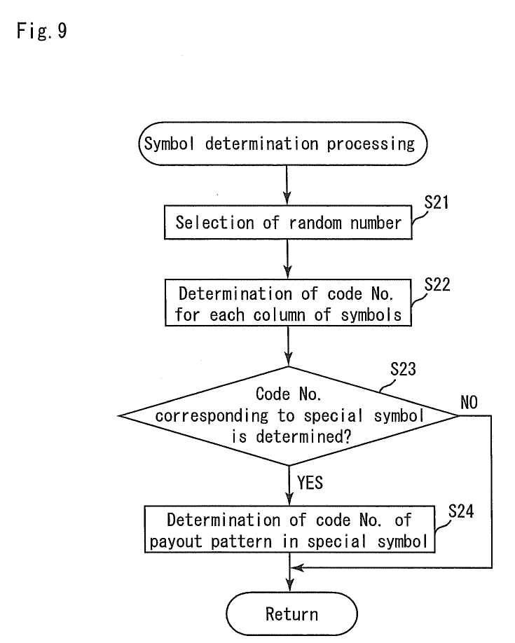

FIG. 9 is a flowchart illustrating a subroutine of the symbol determination processing which is called and executed in step S13 of the subroutine illustrated in FIG. 8. This processing is processing executed by the main CPU 41 through executing the symbol determination program and the payout-pattern determination program stored in the RAM 43.

At first, the main CPU 41 selects random numbers corresponding to respective columns of symbols, out of the numerical range of 0 to 255, by executing a random-number generation program included in the symbol determination program (step S21). The present embodiment describes the case of generating random numbers on a program (the case of using so-called software random numbers). However, in the present invention, a random number generator may be provided, and random numbers may be extracted from the random number generator (so-called software random numbers may be used).

Next, the main CPU 41 determines code Nos. for the respective columns of symbols (see FIG. 3), on the basis of the selected five random numbers (step S22). The code Nos. for the respective columns of symbols correspond to the code Nos. of symbols to be rearranged in the display blocks 28 in the second row, out of the display blocks 28 arranged in the three rows. The main CPU 41 determines a prize by determining code Nos. for the respective columns of symbols. Further, the main CPU 41 stores the determined code Nos. for the respective columns of symbols in the RAM 43.

Next, the main CPU 41 determines whether or not a code No. corresponding to a special symbol 200 has been determined in the processing in step S22 (step S23). When determining in step S23 that a code No. corresponding to a special symbol 200 has not been determined, the main CPU 41 terminates the present subroutine. When determining in step S23 that a code No. corresponding to a special symbol 200 has been determined, the main CPU 41 shifts the processing to step S24.

Next, the main CPU 41 selects a random number corresponding to each payout pattern in the special symbol 200, out of a numerical range from 0 to 255, by executing a random-number generation program included in the payout-pattern determination program, and then, determines the code No. (see FIG. 4) of the payout pattern in the special symbol 200 based on the selected random number (step S24). The code No. of the payout pattern corresponds to the code No. of the payout pattern to be stop-displayed in the payout display frame 201. Then, the main CPU 41 stores the determined code No. of the payout pattern in the RAM 43. Further, in the case that a plurality of code Nos. corresponding to the special symbols 200 have been determined in the processing in step S22, the processing in step S24 is executed for each of the special symbols 200.

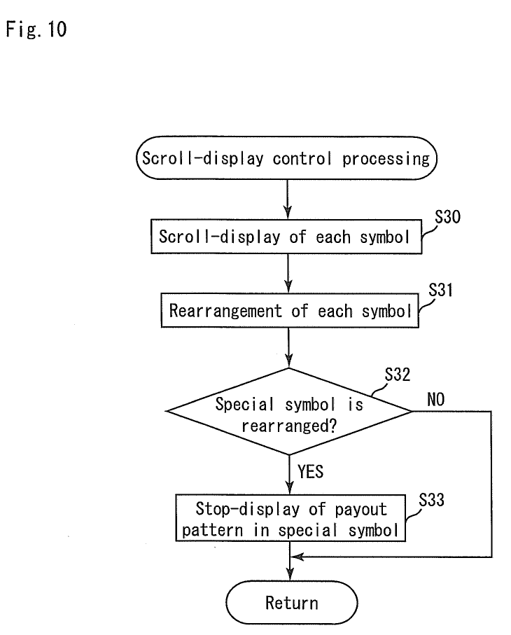

FIG. 10 is a flowchart illustrating a subroutine of scroll-display control processing which is called and executed in step S14 of the subroutine illustrated in FIG. 8.

At first, the main CPU 41 starts scroll-display of all symbols included in the symbol matrix SM to the lower image display panel 16 (step S30). Next, the main CPU 41 rearranges symbols based on the code Nos. for the respective columns of symbols determined in step S13 (step S31).

In the case that the special symbol 200 is rearranged, payout patterns are scroll-displayed in the special symbol 200.

The main CPU 41 determines whether or not the special symbol 200 has been rearranged in step S31 (step S32). When determining in step S32 that the special symbol 200 has not been rearranged, the main CPU 41 terminates the present subroutine. On the other hand, when determining in step S32 that a special symbol 200 has been rearranged, the main CPU 41 shifts the processing to step S33.

The main CPU 41 stop-displays a payout pattern in the special symbol 200 based on the code No. of the payout pattern determined in step S13 (step S33).

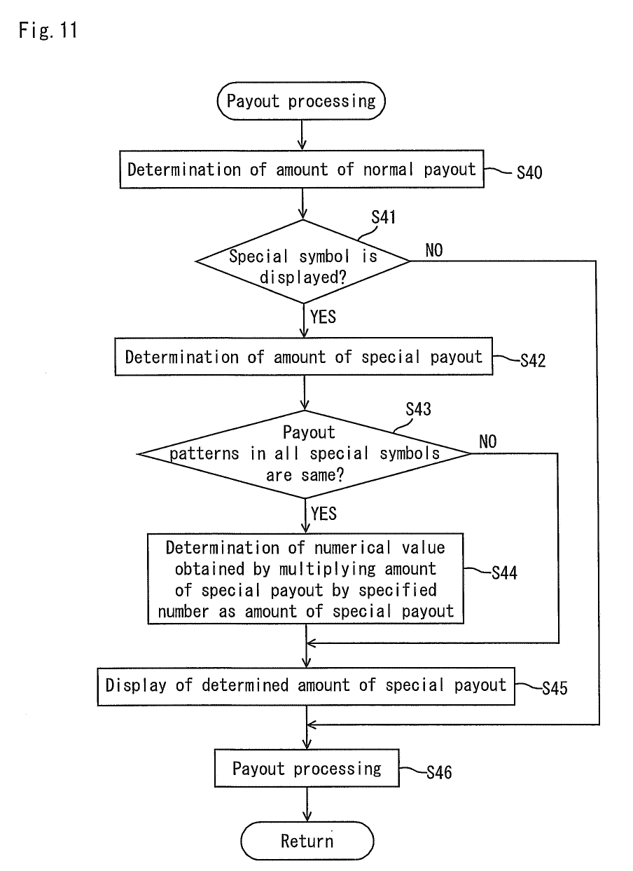

FIG. 11 is a flowchart illustrating a subroutine of payout processing which is called and executed in step S16 of the subroutine illustrated in FIG. 8.

At first, the main CPU 41 determines an amount of normal payout based on the normal symbols (step S40). Then, the main CPU 41 stores the determined amount of normal payout in the RAM 43.

Hereinafter, prizes based on the normal symbols according to the present embodiment will be described.

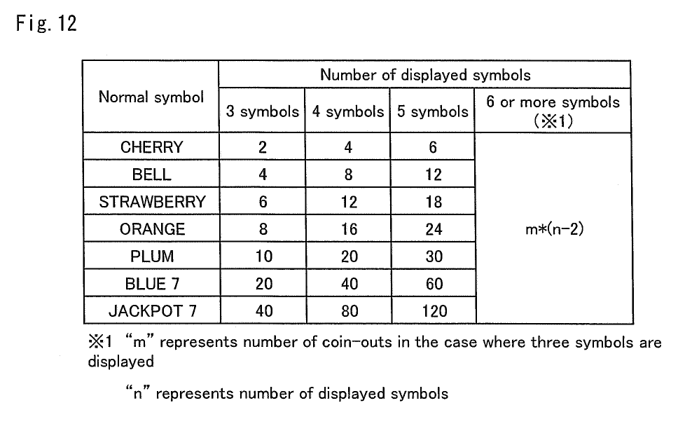

FIG. 12 is a view illustrating a relationship between a plurality of types of prizes and the numbers of coin-outs.

When three or more normal symbols of any type are stop-displayed in the display blocks 28, coins in number illustrated in FIG. 12 are paid out.

For example, when three “CHERRYs” are stop-displayed in the display blocks 28, two coins are paid out. When four “CHERRYs” are stop-displayed in the display blocks 28, four coins are paid out. Further, when six or more “CHERRYs” are stop-displayed in the display blocks 28, 2×(n−2) coins are paid out. Here, “n” represents the number of “CHERRYs” stop-displayed in the display blocks 28. However, in the case that three or more symbols of any type have not been displayed in the display blocks 28, the current game results in no-winning, and payout of coins is not conducted.

Returning to FIG. 11, the main CPU 41 determines whether or not the special symbol 200 has been displayed in the display blocks 28 (step S41). When determining in step S41 that no special symbol 200 has been displayed in the display blocks 28, the main CPU 41 shifts the processing to step S46. On the other hand, when determining in step S41 that the special symbol 200 has been displayed in the display blocks 28, the main CPU 41 shifts the processing to step S42.

The main CPU 41 determines an amount of special payout on the special symbol 200 (step S42). In this processing, the main CPU 41 determines as the amount of special payout, the value of the numeral on the payout pattern stop-displayed in the payout display frame 201. For example, in the case that a numeral of 100 is drawn on the payout pattern stop-displayed in the payout display frame 201, the amount of special payout based on this special symbol 200 is determined to be 100, and 100 coins are paid out as the special payout. Further, in the case that a plurality of special symbols 200 are displayed in the display blocks 28, the total sum of the values of the numerals on the payout patterns stop-displayed in the payout display frames 201 is determined as the amount of special payout. Further, the main CPU 41 stores the determined amount of special payout in the RAM 43.

The main CPU 41 determines whether or not the payout patterns stop-displayed in the payout display frames 201 in all the special symbols 200 displayed in the display blocks 28 are the same (step S43). When determining in step S43 that the payout patterns stop-displayed in the payout display frames 201 in all the special symbols 200 are not the same, the main CPU 41 shifts the processing to step S45. On the other hand, when determining in step S43 that the payout patterns stop-displayed in the payout display frames 201 in all the special symbols 200 are the same, the main CPU 41 shifts the processing to step S44.

The main CPU 41 determines as the amount of special payout, the numerical value obtained by multiplying the amount of special payout determined in step S42 by the specified number of 5 (step S44). Then, the main CPU 41 stores the determined amount of special payout in the RAM 43.

The main CPU 41 displays the amount of special payout determined in step S42 or step S44 to the lower image display panel 16 (step S45). In this processing, for example, as illustrated in FIG. 1E, an amount-of-special-payout determination image 202 indicating that 750 coins will be paid out as the special payout is displayed below the symbol matrix SM.

The main CPU 41 pays out coins based on the amount of normal payout determined in step S40 and/or the amount of special payout determined in step S42 or step S44 (step S46).

As described above, according to the slot machine 10 of the first embodiment, the special symbol 200 having a plurality of payout patterns each with a numeral indicative of the payout value is rearranged to the lower image display panel 16, as well as the normal symbol. Then, in the case that the special symbol 200 is rearranged to the lower image display panel 16, payout patterns having been variably displayed therein are stop-displayed, and based on the numeral on the payout pattern stop-displayed in the payout display frame 201, the amount of special payout is determined. Namely, even when the special symbol 200 is rearranged to the lower image display panel 16, the payout value is not uniquely determined, but the payout value is varied depending on the numeral on the payout pattern stop-displayed in the payout display frame 201, out of the plurality of payout patterns included in the special symbol 200. This prevents games from becoming monotonous, so that the player hardly gets bored.

Further, the rearrangement of the special symbol 200 to the lower image display panel 16 can make the player have a sense of expectancy as to which of the payout patterns to be stop-displayed in the payout display frame 201.

Further, since the numeral indicative of the payout value is drawn on the payout pattern, the player can recognize the payout value easily.

Further, according to the slot machine 10 of the first embodiment, in the case that the numerals on the payout patterns stop-displayed in the payout display frames 201 in all the special symbols 200 rearranged to the lower image display panel 16 are the same, the numerical value obtained by multiplying the amount of payout based on the special symbols 200 by the specified number is determined as the amount of special payout. Namely, in the case that the numerals on the payout patterns stop-displayed in the payout display frames 201 in all the special symbols 200 are the same, the amount of special payout larger than a normal amount is determined. Accordingly, when a plurality of special symbols 200 are rearranged to the lower image display panel 16, the player can be excited about whether or not all the numerals of the payout patterns to be stop-displayed in the payout display frames 201 will be the same, and also, the player can be absorbed in the game.

Further, when the numerals of the payout patterns stop-displayed in the payout display frames 201 in all the special symbols 200 are the same, the amount of special payout larger than the normal amount is determined, which makes the game easy to understand, thereby allowing even a beginner to play the game without having an uncomfortable feeling.

### Second Embodiment

In the first embodiment, there has been described a case where, in the case that the payout patterns stop-displayed in the payout display frames 201 in all special symbols 200 displayed in the display blocks 28 are the same, the numerical value obtained by multiplying the amount of payout based on the special symbols 200 by the specified number is determined as the amount of special payout. In the second embodiment, there will be described a case where, in the case that the number of the special symbols 200 having the payout patterns with the same numerals stop-displayed in the payout display frames 201 therein, out of special symbols 200 displayed in the display blocks 28, is equal to or more than a predetermined number, the numerical value obtained by multiplying the amount of payout based on the special symbols 200 by the specified number is determined as the amount of special payout. The configuration of the second embodiment other than the payout processing is substantially the same as the configuration of the first embodiment, and therefore, only payout processing which is a characteristic part of the second embodiment will be described hereinafter.

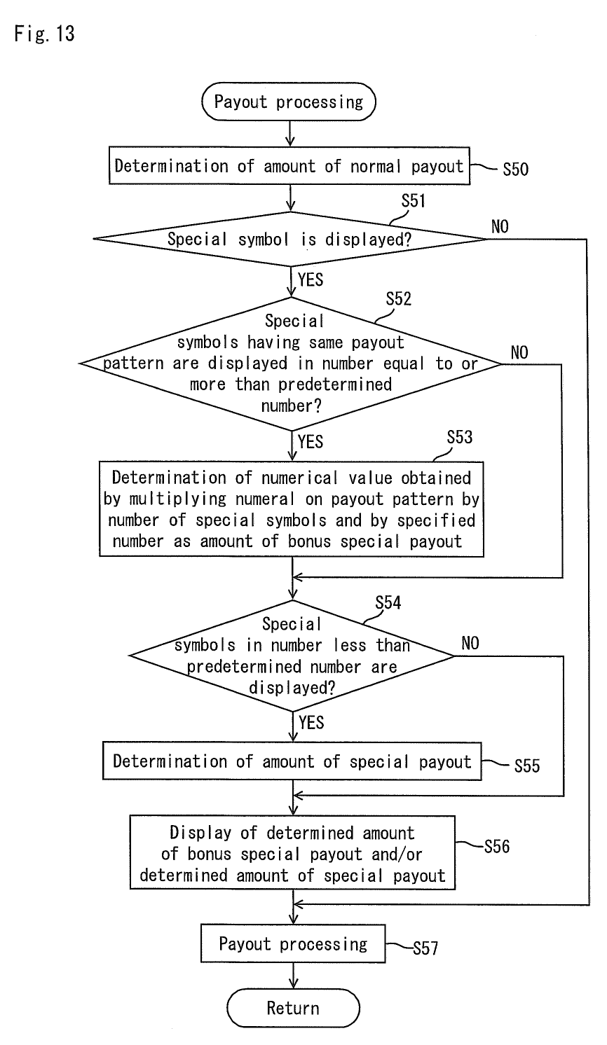

FIG. 13 is a flowchart illustrating a subroutine of payout processing according to the second embodiment.

At first, the main CPU 41 determines the amount of normal payout based on the normal symbols (step S50). Then, the main CPU 41 stores the determined amount of normal payout in the RAM 43.

The processing in step S50 is the same processing as that in the first embodiment and the description thereof will not be repeated here.

Next, the main CPU 41 determines whether or not the special symbol 200 has been displayed in the display blocks 28 (step S51). When determining in step S51 that no special symbol 200 has been displayed in the display blocks 28, the main CPU 41 shifts the processing to step S57. On the other hand, when determining in step S51 that the special symbol 200 has been displayed in the display blocks 28, the main CPU 41 shifts the processing to step S52.

The main CPU 41 determines whether or not the number of special symbols 200 having the same numerals on the payout patterns stop-displayed in the payout display frames 201 therein, out of the special symbols 200 displayed in the display blocks 28, is equal to or more than a predetermined number (step S52). When determining in step S52 that the number of such special symbols 200 is not equal to or more than the predetermined number, the main CPU 41 shifts the processing to step S54. When determining in step S52 that the number of such special symbols 200 is equal to or more than the predetermined number, the main CPU 41 shifts the processing to step S53.

The main CPU 41 determines an amount of bonus special payout by multiplying the numerical value of the same numerals on the payout patterns stop-displayed in the payout display frames 201 in the special symbols 200 which is in number equal to or more than the predetermined number, by the number of these special symbols 200 having the same numerals on the payout patterns stop-displayed therein and also by the specified number of 5 (step S53). Then, the main CPU 41 stores the determined amount of bonus special payout in the RAM 43.

The main CPU 41 determines whether or not there are special symbols 200 having the payout patterns with the same numeral stop-displayed in the payout display frames 201 therein and being less, in number, than the predetermined number, out of the special symbols 200 displayed in the display blocks 28 (step S54). When determining in step S54 that there are no such special symbols 200, the main CPU 41 shifts the processing to step S56. On the other hand, when determining in step S54 that there are such special symbols 200, the main CPU 41 shifts the processing to step S55.

The main CPU 41 determines the amount of special payout based on the special symbols 200 having the same numeral on the payout patterns stop-displayed in the payout display frames 201 therein and being less, in number, than the predetermined number (step S55). In this processing, the main CPU 41 determines as the amount of special payout, the value of the same numeral on the payout patterns stop-displayed in the payout display frames 201 in the special symbols 200 in number less than the predetermined number. For example, in the case that a numeral of 100 is drawn on the payout pattern stop-displayed in the payout display frame 201, the amount of special payout based on this special symbol 200 is determined to be 100, and 100 coins are paid out as the special payout. Further, in the case that there are a plurality of types of special symbols 200 having the same numerals on the payout patterns stop-displayed in the payout display frames 201 therein and being less, in number, than the predetermined number, the main CPU 41 determines as the amount of special payout, the total sum of the values of the numerals on the payout patterns stop-displayed in the payout display frames 201 in the special symbols 200 of the respective types.

Then, the main CPU 41 stores the determined amount of special payout in the RAM 43.

The main CPU 41 displays to the lower image display panel 16 the amount of bonus special payout determined in step S53 and/or the amount of special payout determined in step S55 (step S56).

The main CPU 41 pays out coins based on the amount of normal payout determined in step S50 and/or the amount of bonus special payout determined in step S53, and/or the amount of special payout determined in step S55 (step S57).

As described above, according to the slot machine 10 of the second embodiment, the special symbols 200 having a plurality of payout patterns each with a numeral indicative of the payout value, as well as the normal symbols, are rearranged to the lower image display panel 16. Then, in the case that the special symbols 200 are rearranged to the lower image display panel 16, payout patterns having been variably displayed therein are stop-displayed, and based on the numerals on the payout patterns stop-displayed in the payout display frames 201, the amount of special payout is determined. Namely, even when the special symbols 200 are rearranged to the lower image display panel 16, the payout value is not uniquely determined, but the payout value is varied depending on the numerals on the payout patterns stop-displayed in the payout display frames 201, out of the plurality of payout patterns included in the special symbols 200. This prevents games from becoming monotonous, so that the player hardly gets bored.

Further, the rearrangement of the special symbols 200 to the lower image display panel 16 can make the player have a sense of expectancy as to which of the payout patterns to be stop-displayed in the payout display frames 201.

Further, since a numeral indicative of the payout value is drawn on the payout pattern, the player can recognize the payout value easily.

Further, according to the slot machine 10 of the second embodiment, in the case that the number of the special symbols 200 having the same numerals on the payout patterns stop-displayed in the payout display frames 201 therein is equal to or more than the predetermined number, the numerical value obtained by multiplying the amount of payout based on these special symbols 200 by the specified number is determined as the amount of special payout. Namely, in the case that the number of special symbols 200 having the same numerals on the payout patterns stop-displayed in the payout display frames 201 therein is equal to or more than the predetermined number, the amount of special payout larger than the normal amount is determined. Accordingly, in the case that the special symbols 200 in number equal to or more than the predetermined number are rearranged to the lower image display panel 16, the player can be excited, and also, the player can be absorbed in the game.

Also, by properly setting the predetermined number, it is possible to increase or decrease the opportunities to determine the amount of special payout larger than the normal amount, so that characteristics of the slot machine can be varied.

### Third Embodiment

In the first embodiment, there has been described a case where the special symbols 200 are rearranged in the display blocks 28 in a state where payout patterns are scroll-displayed therein. In the third embodiment, when the special symbols 200 are rearranged in the display blocks 28, payout patterns are stop-displayed therein, and the payout patterns are scroll-displayed and then stop-displayed therein, in the case that the special symbols 200 in number equal to or more than the fixed number are rearranged in the display blocks 28. Further, the amount of special payout is determined only when the special symbols 200 in number equal to or more than the fixed number are rearranged in the display blocks 28. The other configurations of the third embodiment are substantially the same as those of the first embodiment, and therefore, only scroll-display control processing and payout processing which are characteristic parts of the third embodiment will be described hereinafter.

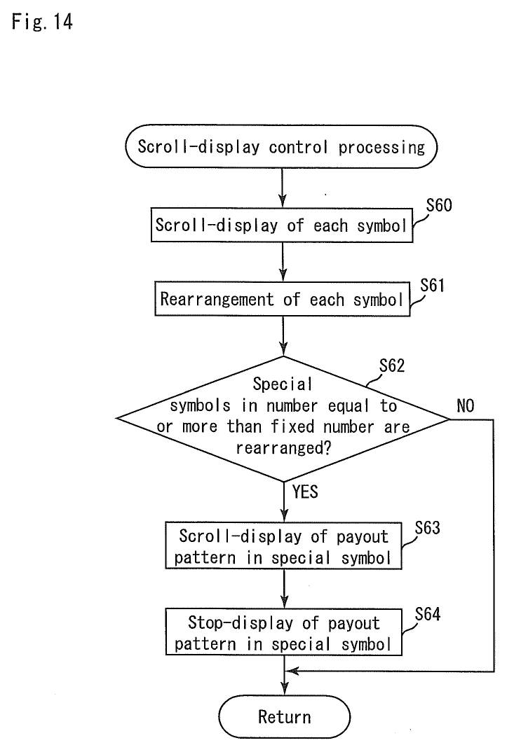

FIG. 14 is a flowchart illustrating a subroutine of the scroll-display control processing according to the third embodiment.

The processing is called and executed in step S14 of the subroutine illustrated in FIG. 8.

At first, the main CPU 41 starts scroll-display of all symbols included in the symbol matrix SM to the lower image display panel 16 (step S60). Next, the main CPU 41 rearranges symbols based on the code Nos. for the respective columns of symbols determined in step S13 (step S61).

In the case that the special symbol 200 is rearranged, payout patterns are scroll-displayed in the special symbol 200.

The main CPU 41 determines whether or not the special symbols 200 in number equal to or more than the fixed number have been rearranged in step S61 (step S62). When determining in step S62 that the special symbols 200 in number equal to or more than the fixed number has not been rearranged, the main CPU 41 terminates the present subroutine. On the other hand, when determining in step S62 that the special symbols 200 in number equal to or more than the fixed number have been rearranged, the main CPU 41 shifts the processing to step S63.

The main CPU 41 displays, in a scrolling manner, the payout patterns displayed in the special symbols 200 (step S63). Further, the main CPU 41 stop-displays the payout patterns based on the code Nos. of the payout patterns of the respective special symbols 200 determined in step S13 (step S64).

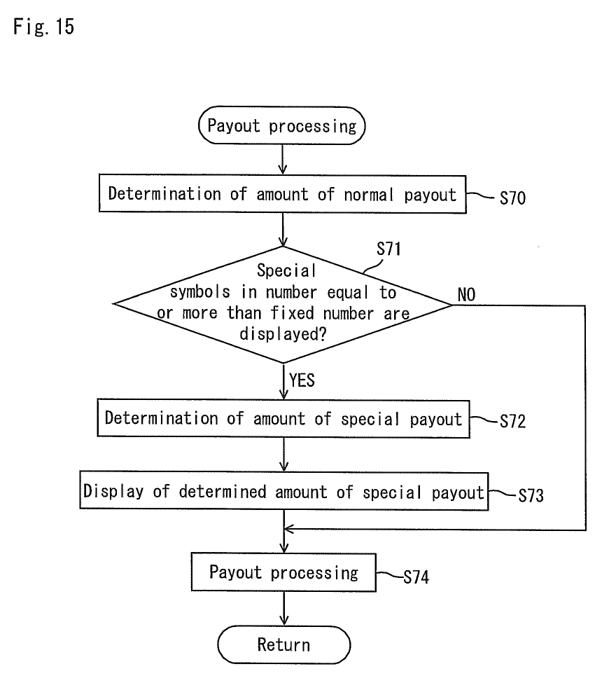

FIG. 15 is a flowchart illustrating a subroutine of the payout processing according to the third embodiment.

This processing is processing which is called and executed in step S16 of the subroutine illustrated in FIG. 8.

At first, the main CPU 41 determines the amount of normal payout based on the normal symbols (step S70). Then, the main CPU 41 stores the determined amount of normal payout in the RAM 43. The processing in step S70 is the same processing as that in the first embodiment and the description thereof will not be repeated here.

Next, the main CPU 41 determines whether or not the special symbols 200 in number equal to or more than the fixed number have been displayed in the display blocks 28 (step S71). When determining in step S71 that the special symbols 200 in number equal to or more than the fixed number have not been displayed in the display blocks 28, the main CPU 41 shifts the processing to step S74. On the other hand, when determining in step S71 that the special symbols 200 in number equal to or more than the fixed number have been displayed in the display blocks 28, the main CPU 41 shifts the processing to step S72.

The main CPU 41 determines the amount of special payout based on the special symbols 200 (step S72). In this processing, the main CPU 41 determines as the amount of special payout, the value of the same numeral on the payout patterns stop-displayed in the payout display frames 201 in the special symbols 200 which is in number less than the predetermined number. For example, in the case that a numeral of 100 is drawn on the payout pattern stop-displayed in the payout display frame 201, the amount of special payout based on this special symbol 200 is determined to be 100, and 100 coins are paid out as the special payout. Further, in the case that a plurality of the special symbols 200 are displayed in the display blocks 28, the total sum of the values of the numerals on the payout patterns stop-displayed in the payout display frames 201 therein is determined as the amount of special payout.

The main CPU 41 displays to the lower image display panel 16 the amount of special payout determined in step S72 (step S73).

The main CPU 41 pays out coins based on the amount of normal payout determined in step S70, and/or the amount of special payout determined in step S72 (step S74).

As described above, according to the slot machine 10 of the third embodiment, the special symbols 200 having a plurality of the payout patterns each with a numeral indicative of the payout value, as well as normal symbols, are rearranged to the lower image display panel 16. Further, in the case that the special symbols 200 in number equal to or more than the fixed number are rearranged to the lower image display panel 16, the payout patterns are variably displayed and then stop-displayed therein, and based on the numerals on the payout patterns stop-displayed in the payout display frames 201, the amount of special payout is determined. Namely, even when the special symbols 200 are rearranged to the lower image display panel 16, in the case that the number of the special symbols 200 rearranged to the lower image display panel 16 is not equal to or more than the fixed number, the payout patterns are not variably displayed therein, and the amount of special payout is not determined. This can strongly impress the existence of the special symbols 200 on the player.

Further, even when the payout patterns are variably displayed in special symbols 200, the payout value is not uniquely determined, but the payout value is varied depending on the numerals on the payout patterns stop-displayed in the payout display frames 201, out of the plurality of the payout patterns included in the special symbols 200. This prevents games from becoming monotonous, so that the player hardly gets bored.

Further, when variable display of the payout patterns in the special symbols 200 is started, this can make the player have a sense of expectancy as to which of the payout designs to be stop-displayed.

Further, while there has been described a case where the number of types of the special symbols is one in the present embodiment, there is no particular limitation on the number of types of the special symbols in the present invention, and for example, the number of types of the special symbols may be five.

Further, while there has been described a case where numerals indicative of payout values are drawn on the payout patterns in the present embodiment, there is no particular limitation on the payout patterns in the present invention, provided that the payout patterns are associated with payout values, and for example, patterns which are not associated with numerals may be drawn on the payout patterns.

Further, while there has been described a case where the specified number is preliminarily determined in the present embodiment, a plurality of specified numbers may be provided and a single specified number may be selected out of the plurality of specified numbers through a lottery in the present invention.

Further, while there has been described a case where the predetermined number is preliminarily determined in the present embodiment, a plurality of predetermined numbers may be provided and a single predetermined number may be selected out of the plurality of predetermined numbers through a lottery in the present invention.

Further, while there has been described a case where the fixed number is preliminarily determined in the present embodiment, a plurality of fixed numbers may be provided and a single fixed number may be selected out of the plurality of fixed numbers through a lottery in the present invention.

Further, although, in the present invention, there has been described the case where the slot machine 10 is a video slot machine, the gaming apparatus according to the present invention may be a mechanical slot machine including reels.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patents of the United States is:

1. A slot machine comprising:
a display for arranging thereto a normal symbol and a special symbol having a plurality of payout patterns each associated with a payout value; and
a controller, said controller programmed to execute processing of
(A) rearranging said normal symbol and/or said special symbol to said display,
(B) stop-displaying said payout patterns having been variably displayed, in the case that said special symbol has been rearranged to said display in said processing (A),
(C) determining an amount of normal payout based on a number of said normal symbol for each type, said normal symbol having been rearranged in said processing (A), and
(D) determining an amount of special payout based on a type of said payout pattern stop-displayed in said processing (B).

2. The slot machine according to claim 1,
wherein
said controller is further programmed to execute processing of
(E) determining as the amount of special payout a numerical value obtained by multiplying said amount of special payout determined in said processing (D) by a specified number, in the case that the types of said payout patterns stop-displayed in said processing (B) in all of said special symbols rearranged to said display in said processing (A) are the same.

3. The slot machine according to claim 1,
wherein
said processing (D) includes processing of
(D−1) determining as the amount of special payout a numerical value obtained by multiplying said amount of special payout determined based on the type and a number of the payout pattern by the specified number, in the case that a number of said special symbols having the same type of said payout patterns stop-displayed in said processing (B), out of said special symbols rearranged to said display in said processing (A), is equal to or more than a predetermined number.

4. A slot machine comprising:
a display for arranging thereto a normal symbol and a special symbol having a plurality of payout patterns each with a numeral indicative of a payout value; and
a controller, said controller programmed to execute processing of
(A) rearranging said normal symbol and/or said special symbol to said display,
(B) stop-displaying said payout patterns having been variably displayed, in the case that said special symbol has been rearranged to said display in said processing (A),
(C) determining an amount of normal payout based on the number of said normal symbol for each type, said normal symbol having been rearranged in said processing (A), and
(D) determining an amount of special payout based on the numeral on said payout pattern stop-displayed in said processing (B).

5. The slot machine according to claim 4,
wherein
said processing (D) is processing of
determining as the amount of special payout a numerical value obtained by multiplying the value of the numeral on the payout patterns in said special symbol by a number of said special symbols each having said payout pattern with the numeral stop-displayed therein and by a specified number, in the case that the numerals on said payout patterns stop-displayed in said processing (B) in all of said special symbols rearranged to said display in said processing (A) are the same.

6. The slot machine according to claim 4,
wherein
said processing (D) includes processing of
(D−1) determining as the amount of special payout a numerical value obtained by multiplying the value of the numeral on the payout patterns in said special symbol in number equal to or more than a predetermined number, by a number of said special symbol having said payout pattern with the numeral stop-displayed therein and by a specified number, in the case that the number of said special symbol having said payout pattern with the same numeral stop-displayed therein in said processing (B), out of said special symbol rearranged to said display in said processing (A), is equal to or more than the predetermined number.

7. A slot machine comprising:
a display for arranging thereto a normal symbol and a special symbol having a plurality of payout patterns each with a numeral indicative of a payout value; and
a controller, said controller programmed to execute processing of
(A) rearranging said normal symbol and/or said special symbol having said payout patterns stop-displayed therein to said display,
(B) determining whether or not said special symbol in number equal to or more than a fixed number has been rearranged to said display in said processing (A),
(C) stop-displaying said payout patterns after a variable display thereof, when determining in said processing (B) that said special symbol in number equal to or more than the fixed number has been rearranged,
(D) determining an amount of normal payout based on a number of said normal symbol for each type, said normal symbol having been rearranged in said processing (A), and
(E) determining an amount of special payout based on the numeral on said payout pattern stop-displayed in said processing (C).

8. A control method of a slot machine, said control method comprising steps of:
(A) rearranging to a display a normal symbol and/or a special symbol having a plurality of payout patterns each associated with a payout value;
(B) stop-displaying said payout patterns having been variably displayed, in the case that said special symbol has been rearranged to said display in said step (A);
(C) determining an amount of normal payout based on a number of said normal symbol for each type, said normal symbol having been rearranged in said step (A), and
(D) determining an amount of special payout based on a type of said payout pattern stop-displayed in said step (B).
